(19) United States
(12) Patent Application Publication
(10) Pub. No.: US 2004/0107852 A1
(43) Pub. Date: Jun. 10, 2004

(54) Description of related art

(76) Inventor: Leonard I. Tafel, Mt. Prospect, IL (US)

Correspondence Address: LEONARD TAFEL, 1821 AZALEA LN., MT. PROSPECT, IL, 60056, US

(21) Appl. No.: 10/314,582

(22) Filed: Dec. 9, 2002

(51) Int. Cl. B41F 31/00

(52) U.S. Cl. 101/350.1

(57) ABSTRACT

A economical liquid metering device which dispenses in a digital steps the supply of liquid provided to predetermined circumferential stripes on a rotating surface. Further advantages are: the ease of liquid change because the entire mechanism which is in contact with the liquid, is exchangeable; the liquid is protected from drying and contamination; the liquid remaining at the end of a run, may be safely reused at a later time; the liquid is dispensed in digitally predictable quantities, may be reused at a later time, and each computer pulse dispenses a predictable quantity of the liquid. To provide a continuous flow, the volume and operation rate between pump pulses may be controlled, so that the dispensing rate becomes substantially continuous.

### DESCRIPTION OF RELATED ART

The most commonly used means for regulating the supply of ink across the width of a printing press has been the use of a doctor blade acting against a rotating fountain roller, which is driven by the press, either with gears or ratchets. The roller and doctor blade form a trough filled with ink, with an adjustable width slit near the bottom and sealing devices at the ends. Additional mechanism must be provided to transfer the ink from the slow-speed fountain roller to the high-speed inking rollers which are transferring ink to the printing plate. The RPM of these inking rollers is in the range of 1500 RPM per minute, while the fountain roller operates at around 10 RPM. One such way of matching the speeds is a “ductor roller” which alternately contacts the slow fountain roller and then contacts, and immediately is accelerated by, the high-speed ink rollers. This acceleration and deceleration severely impacts the press components. Another system uses a high-speed knurled inker roller, which is closely spaced to the fountain roller. This knurled roller “skims-off” ink on the fountain roller above a certain thickness. These systems are seriously affected by the temperatures of the ink and the press components, by the press speed and by the length of time the press has been running, by wear, by adjustment of the rollers, and by ink rheoscopic variables, among many other things.

Some presses utilize specially designed variable-volume ink pumps. The pump modules are usually in a row across the press, each pump module serving between an inch, and inch-and-a-half of web width.

Ink is a very abrasive liquid which wears-out machine sliding elements such as pistons and valves. and the ink dries hard when exposed to air, adhering mechanisms together. Also, these pumps are expensive, difficult to clean, require maintenance, deviate from set volume, and have many expensive wearing parts which gradually deteriorate over the life of the device, causing leakage and inaccurate control. These drawbacks and other have prevented existing ink pump designs from being widely adopted.

Examples of such prior art are listed:

The Reed U.S. Pat. No. 2,866,411 teaches a central group of variable stroke piston pumps connected by tubes to an ink rail. Distancing the pump from the roller onto which the ink will be dispensed increases cleaning problems.

The Hegeman U.S. Pat. No. 3,018,727 teaches a piston pump with sliding valves. Sliding surfaces immersed in abrasive ink will wear and leak rapidly.

The Fusco U.S. Pat. No. 3,366,051 teaches the use of a plurality of rotary axial-piston variable-volume ink pumps with improved drive.

The Noon U.S. Pat. No. 3,298,305 pumps a steady stream of ink onto a roller. There is a lot of exposure to air and other contaminants.

The Braun U.S. Pat. No. 4,332,196 teaches the use of a series of slide valves which regulate ink volume by timing the “on” position.

The Bryer U.S. Pat. No. 4,020,760 teaches the use of a variable stroke axial piston pump with a screw acting against a spring to vary the allowable stroke of the piston. There are many parts in this patent that will wear and leak.

The Niemiro U.S. Pat. No. 5,027,706 teaches a timed-opening rapidly acting ink valve The varying rheoscopic properties of ink make control in this manner subject to volumetric variations.

The Nikkamen U.S. Pat. No. 5,405,252 teaches the use of a complex diaphragm pump.

The Uera U.S. Pat. No. 5,526,745 teaches a piston pump driven by a stepping motor. This device has many working parts exposed to the abrasiveness of ink.

The Kirihara U.S. Pat. No. 5,575,208 teaches a microprocessor controlled piston type ink pump.

The Kawata U.S. Pat. No. 6,336,405 teaches yet another variable volume piston pump.

### SUMMARY OF THE INVENTION

The present system discloses a system to supply liquid to a dispensing pump, a digital liquid dispensing and metering pump, and a nozzle.

### BRIEF DESCRIPTION OF THE DRAWINGS

FIG. 1 is a pictorial view showing a linear pneumatic parastaltic pump with the tubing enclosure in the closed and operating position.

FIG. 2 is a pictorial view showing a linear pneumatic parastaltic pump with the tubing enclosure in its open, loading position, so the ink container and its tubes may be easily inserted.

FIG. 3 is a cross-section of FIG. 2 with lower assembly rotated down into the loading position.

FIG. 4 is a cross-sectional view with the roller assembly fully retracted.

FIG. 5 is a cross-sectional view with cylinder extended and the roller assembly at its extreme forward position.

FIG. 6 is a cross-sectional view with the roller assembly in the process of being retracted.

FIG. 7 shows flared and formed tubing ends which serve to distribute the ink along the length of the roller and close together, excluding air and contaminants and preventing dripping.

FIG. 8 is a pictorial view of the invention in an alternate embodiment showing a solenoid and ratchet driven rotary peristaltic pump.

FIG. 9 is a sectional view of FIG. 8 with a rotary peristaltic pump being driven by a solenoid and ratchet; the solenoid is shown de-energized.

FIG. 10 is a view of FIG. 9, with the solenoid shown energized.

FIG. 11 is a rear view of several of the solenoids and associated mechanisms of FIG. 8.

FIG. 12 is a sectional view through the roller shaft showing the rollers compressing the tubes, the roller clutches, and the manual feed lever.

FIG. 13 is a rear sectional view of yet another embodiment of the present invention showing a press, driven rotary peristaltic pump driven by a ratchet, at the end of its maximum feed stroke.

FIG. 14 is a view of FIG. 13 showing the press driven rotary peristaltic pump at the beginning of its feed stroke using a unidirectional clutch instead of a ratchet.

### DETAILED DESCRIPTION OF THE INVENTION

While peristaltic pumps are known, the present system drives them, and configures them, in conjunction with other novel entities into an improved, digitally controlled system especially applicable to Graphic arts. Although the descriptions and illustrations refer to a printing press and the application of ink, the present method and apparatus will be understood to apply to various applications, and liquids of various compositions. Referring now specifically to the drawings:

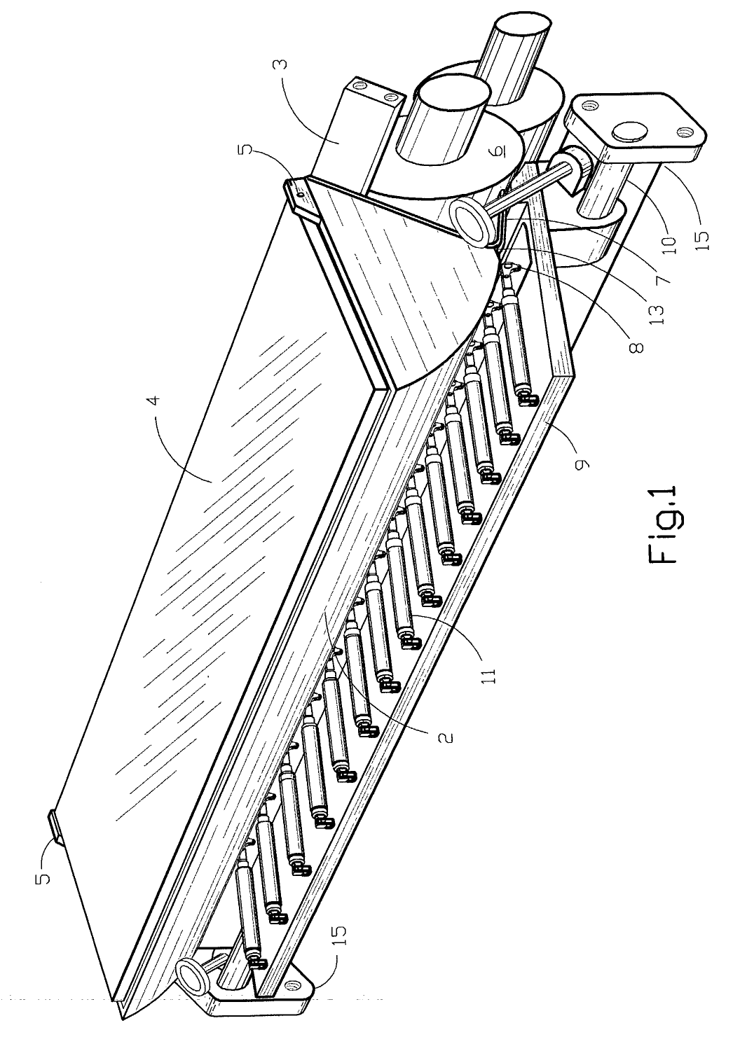

FIG. 1 shows the preferred embodiment in accordance with the present invention, with the pneumatic cylinder 11 retracted. The illustrated system meters printing inks contained in a flexible pressurized reservoir 1 (see FIG. 2) supported by chamber walls 2 and forcibly contained by a pressure plate 4 hinged about pins 5, said chamber walls being supported by a crossbrace 3. Ink in said reservoir is dispensed onto a printing press roller 6 through flexible tubes 7 by peristaltic action of rollers 8, said rollers being forcibly supported in a bracket 16 by wheels 20 and urged against said tubes by a support plate 9 rotatably supported about pin 10. Each of said rollers is caused to reciprocate in a substantially linear path driven by its associated pneumatic cylinder 11 controlled by an individual, commercially available pneumatic valve for each of said cylinders, each of said valves being activated by signals from a computer control means (not shown).

The cover 4 is a pressure plate that is caused to press against the reservoir to provide an equal ink pressure to all the pumps by its own weight and optionally, by an operative means such as a spring or pneumatic device. Proximity sensor 25 indicates to the control system when the reservoir 1 is substantially depleted and alerts the operator. Said reservoir is manually filled through capped opening 28 by the operator, or by an automatic filling means, such as a hose from a central tank with a valve connected to said opening, said valve being opened to permit liquid from said central tank to enter said reservoir by a signal from sensor 25 upon partial depletion of said reservoir, as shown in FIG. 10.

FIG. 2 is a pictorial view showing FIG. 1 with a support plate 9 and its attached mechanisms rotated about a pivot 10 into a open, loading position and showing the reservoir 1 already inserted and supported by reservoir chamber walls 2 with its dependent hoses 7 protruding downward through a slotted opening 13 in the bottom of said walls. The hoses are positioned such that when said support plate is rotated upwards into the running position about pivot 10 which is rotatably mounted in crossbrace 15, the tapered grooves 12, and the slots 14 in support plate 9 forcibly position said hoses centrally above the rollers 8.

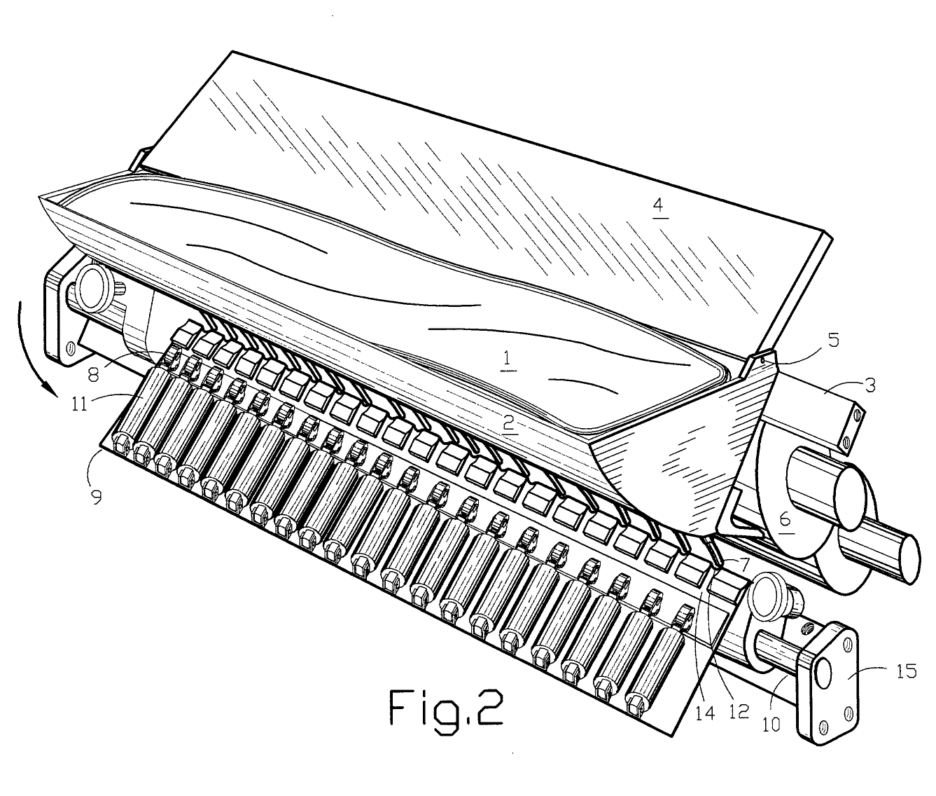

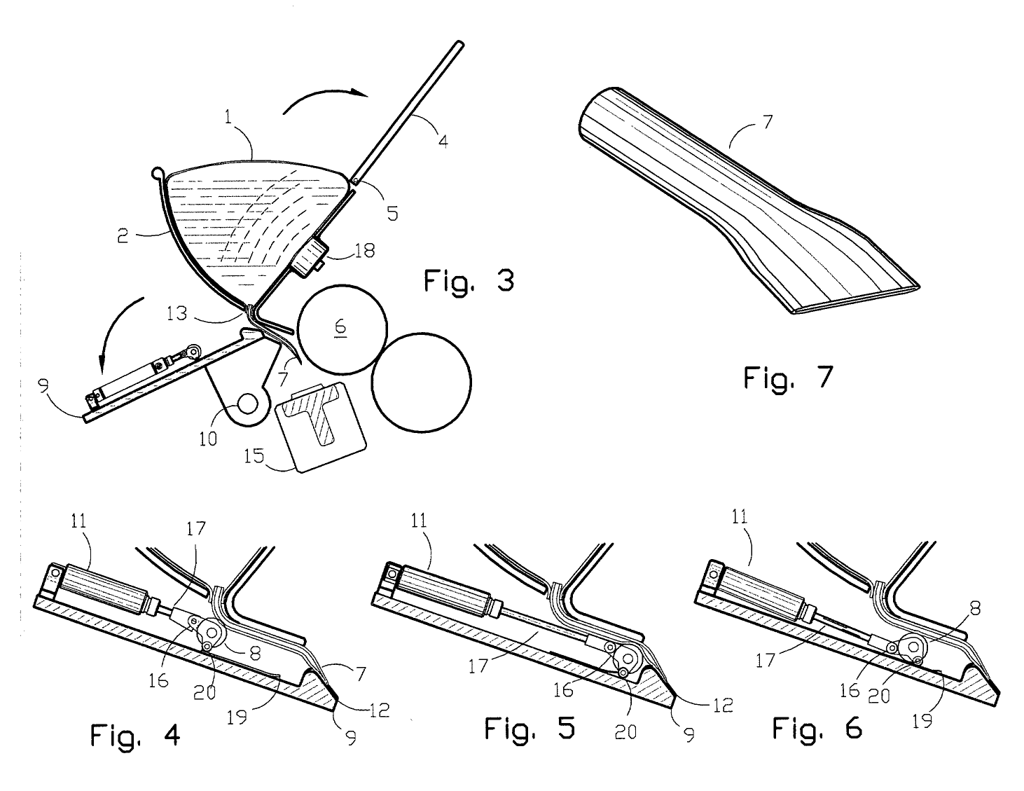

FIG. 3 is a cross-section of FIG. 2 showing hoses 7 protruding downward from reservoir 1 through slotted openings 13 which are shown in more detail in FIGS. 4-6. For very viscous liquids, a plurality of computer-controlled combination heater-vibrators 18 are spaced along the flat surface of wall 2 to improve fluid-flow by lowering apparent-viscosity.

FIG. 4 is a cross-sectional view of FIG. 1 with the roller 8, rotatably supported in bracket 16 at the beginning of a dispensing stroke, and with the pneumatic-cylinder 11, and the cylinder-rod and rod-end assembly 17 fully retracted at the beginning of a dispensing stroke.

FIG. 5 shows cylinder 11, rod-assy. 17, bracket 16 and roller 8 at the end of a dispensing stroke, with support wheel 20 just past the bent up end of flat spring 19.

FIG. 6 shows the return stroke of said pneumatic cylinder, flat spring 19 causing bracket 16 to rotate counter-clockwise sufficiently to move roller 8 towards support plate 9 thereby substantially removing pressure from tube 7, and preventing the roller from moving the liquid contained in the tube in a retrograde direction.

FIG. 7 is a pictorial view of a representative length of a dispensing end of the tubes, showing the flared and flattened ends of flexible tubes 7 being slightly bent down. This shape acts as a dispensing means by spreading the ink along the length of a roller, acts as a valve to prevent dripping and retrograde movement of the liquid being dispensed.

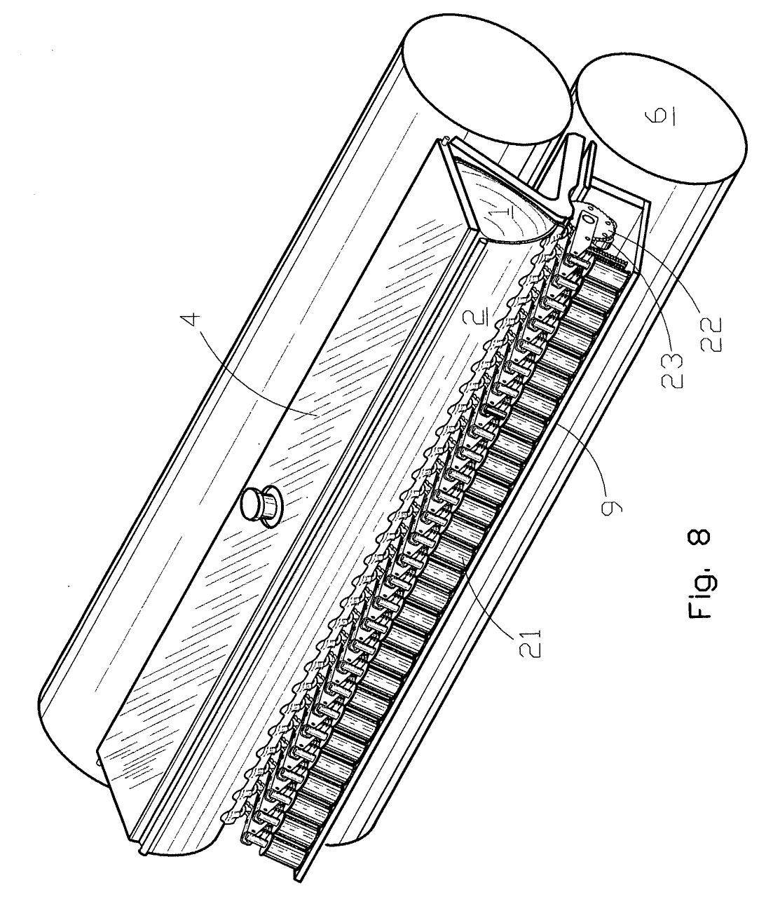

FIG. 8 shows a pictorial view of an alternate embodiment in the running position wherein the rollers 23 which act peristaltically on the tubes, move in a circular path, rather than a linear path. The rollers are driven by operative device 21 fastened to support plate 9 and acting through a ratchet 22 or a unidirectional clutch, so disposed that said rollers move in only one direction, which in the present view, is clockwise.

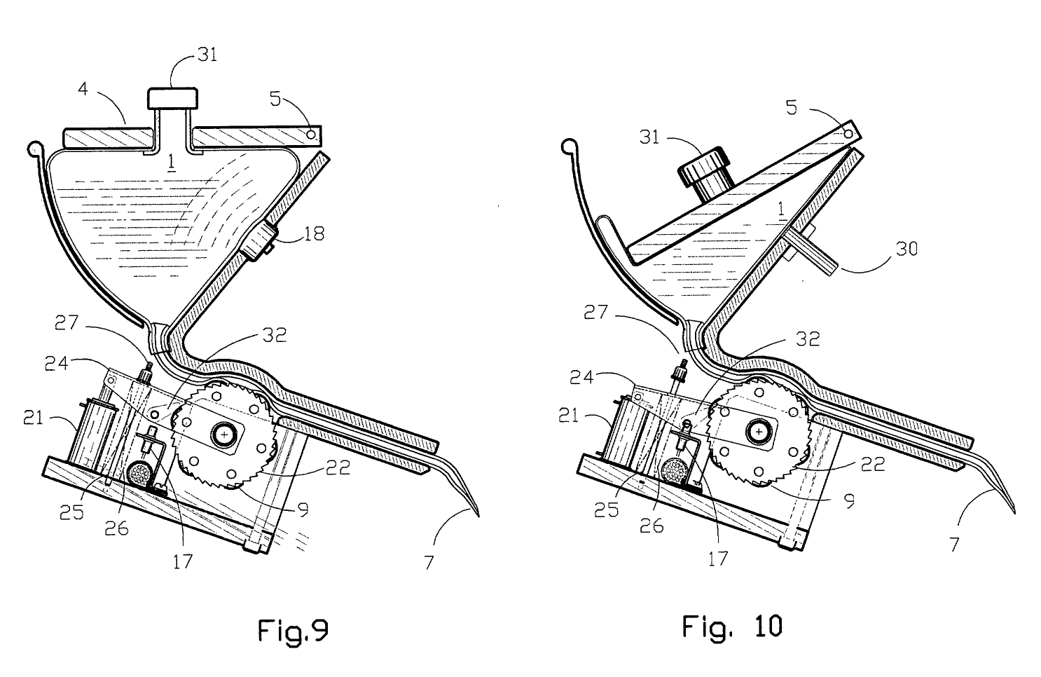

FIG. 9 is a sectional view of the alternate embodiment illustrated in FIG. 8, that more fully illustrates this arrangement. Rollers 23 are supported and moved in a rotary path by a ratchet 22 which is caused to incrementally rotate in clockwise direction by a pawl 32 rotatably supported on driven lever 24, said lever being operatively rotated through a fixed angular excursion in a clockwise direction by spring 25, and in a counterclockwise direction by operative device 21. The stop screws 26 with adjusting nuts 27 limit the clockwise movement of levers 24 and also may used to provide a temporary emergency mechanical means to control the flow ink in case of some types of computer control failure-modes. If the system is configured to use a solenoid as operative device 21, the rotational velocity of the clockwise motion of lever 24 may be controlled by only partially energizing said solenoid with a reduced voltage, thereby partially opposing the force of said spring 25, and reducing the angular velocity of said lever.

If the system is configured to use a pneumatic cylinder as operative means 21, restricting the air flow exiting from the rod end of said cylinder can similarly reduce the rotational velocity of said lever. Reducing the rotational velocity of lever 24 will reduce the velocity of all the oscillating and rotating components, thereby reducing the rate at which said liquid is dispensed, allowing the interval of time during which the liquid is being dispensed to approximate the interval between control pulses, thereby enabling the control means to regulate the rate of dispensing such that the dispensed volume is substantially uniform over time. To optionally provide this more uniform flow of liquid, sensor 39 signals the control system that lever 24 has moved through a predetermined portion of its total stroke; the control system notes the time interval from the de-energizing of the solenoid until a signal is received. Said computer control records the time interval to rotate through a given distance obtained on prior cycles, providing predictive information to optimize and control the velocity of said lever to provide a uniform flow of ink to the press.

FIG. 10 shows a cross section of alternate embodiment FIG. 8 similar to FIG. 9 except that operative device 21 is retracted down, and lever 24 is in its maximum counterclockwise position. Reservoir 1 is shown in a partially depleted condition and pressure plate 4 has moved counterclockwise about pivot 5 to maintain pressure in said reservoir.

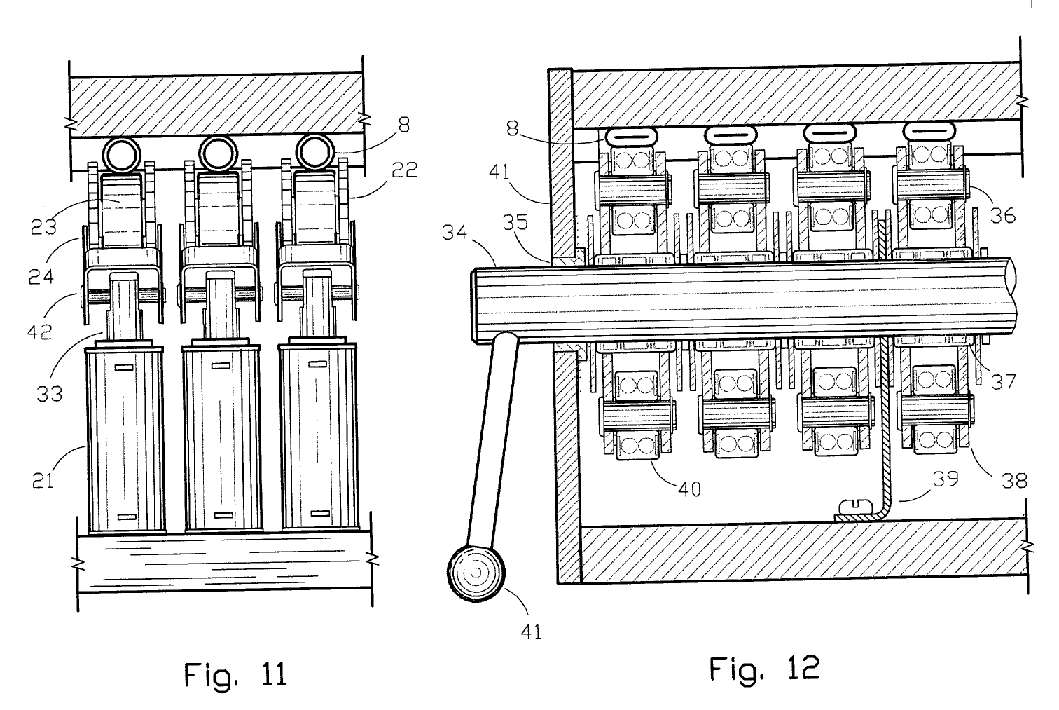

FIG. 11 shows a left view of three of the peristaltic pumps wherein the operative means 21 which drives the ratchet is shown as a solenoid. The solenoid pulls plunger 33 connected to lever 24 by pin 41, causing the lever to rotate. The actual number of ratchet-pump assemblies is dependent on the width of the particular press. Roller 23 supported on axle 36 which presses together opposing walls of tubing 7, forming said tubing into an oboval shape and sealing flow through the tube past the pinch-point. Ratchet 22 is supported by a bearing and unidirectional clutch 37 which rotates about common shaft 34 supporting the plurality of pump roller assemblies.

FIG. 12 shows a cross-sectional view of FIG. 8 through the shaft 34, said shaft being rotationally supported by bearings 35 pressed into a bracket 31 at each end, and by intermediate brackets 29, said brackets being spaced throughout the length of said shaft. Lever 29 at each end provides a manual override, allowing the press operator to manually supply ink over the entire width of the press at the beginning of a press run by rotating shaft 34, engaging unidirectional clutch 37 and thereby overriding the ratchet mechanism and directly driving rollers 30.

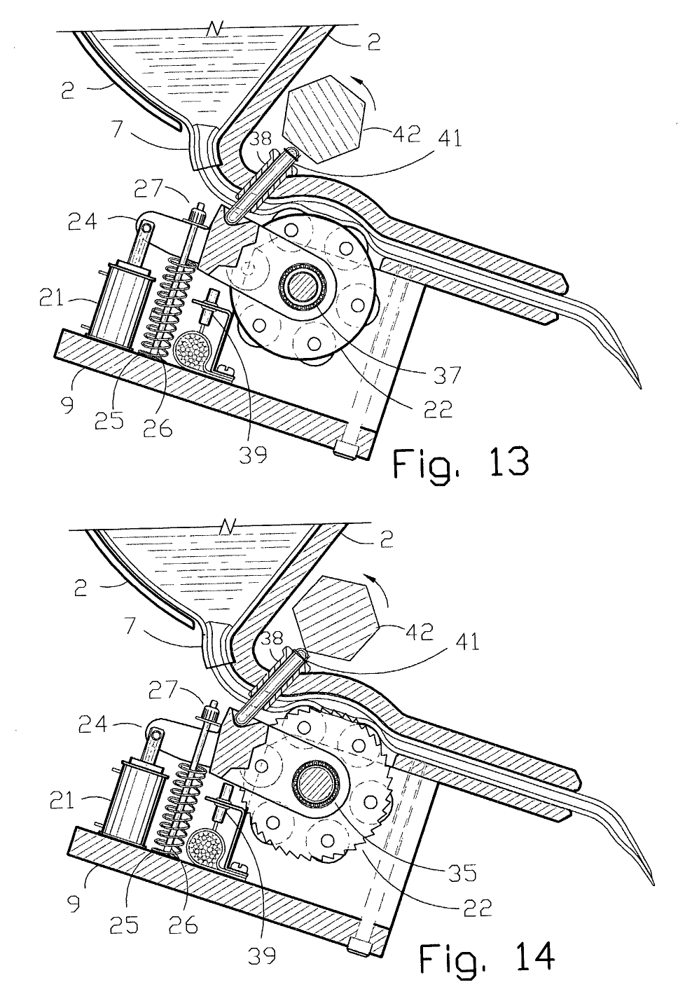

FIG. 13 shows yet another embodiment wherein a hexagonal cam 42 driven at either a fixed or variable ratio to the web speed, provides a rotary oscillation to lever 24 through cam-follower pin 41 which drives the peristaltic pump through either a unidirectional clutch as shown in FIG. 13, or a ratchet as shown in FIG. 14.

FIG. 14 shows the pin at the peak of the hexagonal cam lobe. To reduce the liquid volume from the maximum, operative means 21 is actuated when the cam is at this peak position, and then deactivated at between 30 deg. and 60 deg. of angular rotation later to dispense an amount between minimum and maximum will be dispensed, an earlier release by operative means 21 providing a greater amount to be dispensed as opposed to a later release. If the operative means remains activated continuously, there will be no pumping action, and the lever 24 will remain in the position shown in FIG. 14. Cam 42 is most simply and economically driven by a gear engaging the gear-train of the printing press. Other mechanical means may be used to vary the displacement of lever 24, including operative means to engage and disengage the pawl 32. An electronic speed controlled motor to drive the cam provides for greater control sophistication, but at additional cost;

1: A system for metering the thickness of a liquid dispensed onto a surface comprising:
a control system for digitally controlling a liquid metering means,
a means for supplying at a moderate, uniform pressure, a liquid to a plurality of said metering means wherein all parts of said dispensing system in contact with said liquid are easily and economically disposable and exchangeable,
a plurality of liquid metering means, each driven in a digital manner to provide precise amounts of liquid responsive to each signal pulse, or group of pulses, from said control system,
and means for dispensing said measured amounts onto said surface.

2: The device of claim 1 wherein the means for supplying said liquid to a plurality of metering means includes an elastomeric-film liquid reservoir configured to have a plurality of dependent tubes,
enclosed in a container having a lid so disposed as to forcibly pivot down on the top of said elastomeric container,
thereby equally pressurizing the liquid supplied to each liquid measuring means,
a sensing means to alert the control system that said liquid supply is substantially depleted,

3: The device in claim 1 wherein the liquid metering means is driven in a stepwise manner by a spring acting in opposition to a solenoid,
said solenoid being energized by said control system, and
said controls having the capacity to selectively partially de-energize said solenoid responsive to the time interval required for a partial stroke,
so disposed as to control the rate of movement of said metering means whereby said liquid is dispensed in a virtually continuous stream.

4: The device in claim 1 wherein the ends of said elastomeric dispensing tubing walls are flared and flattened closed but not sealed together, so disposed as
to provide an orifice to distribute said metered liquid along said surface,
to prevent retrograde motion of the liquid contained therein,
to provide a closure when not dispensing to prevent dripping of said liquid,
and to prevent entrance of air and contaminants into said orifice.

5: The device in claim 1 wherein part of the device may be pivoted open along the path of said tubes to facilitate loading and unloading of the elastomeric storage reservoir and its associated row of tubes.

6: The device in claim 1 wherein the ratcheting lever is caused to reciprocate by a plurality of cam mechanisms driven at a speed proportional to the speed of an associated printing press,
a solenoid being provided to intercept said cam mechanism,
whereby the amount of ink dispensed is determined by the time, in relation to the rotation of said cam in the movement cycle at which the motion of said mechanism is intercepted.

7: The device in claim 1 wherein the operative means is a pneumatic cylinder operating a linear peristaltic pump,
so disposed that a roller is forcibly pressed against the tubes on the forward stroke of the pneumatic cylinder,
with the roller pressure being released on the backward stroke,
means to prevent retrograde motion of the metered liquid during said backward stroke,
said pneumatic cylinder operating responsive to signals from said control means.

8: A system for metering the thickness of ink dispensed onto a rapidly moving roller surface comprising:
a control system for digitally controlling a ink metering means,
an elastomeric film bag container configured to have a plurality of dispensing tubes, wherein all parts of said dispensing system in contact with said ink are easily and economically disposable and exchangeable,
a lid so disposed as to forcibly pivot down on the top of said container, thereby pressurizing the liquid supplied to each ink measuring means,
a sensor to alert the control system that the ink supply is partially depleted,
a plurality of ink metering means, each driven in a digital manner to provide precise amounts of ink responsive to each signal pulse, or group of pulses from said control system,
metering means regulating the dispensing rate of said measured amounts of ink so disposed that the series of liquid pulses are substantially continuous,
means for dispensing said measured amounts across the circumferential surface of a rotating roller,
wherein the ends of said elastomeric dispensing tubing walls are flared and flattened closed but not sealed together, so disposed as
to provide an orifice to distribute said metered liquid along said surface,
to prevent retrograde motion of the ink contained therein,
to provide a closure when not dispensing to prevent the ink from dripping, and to prevent entrance of air and contaminants into said orifice.

9: A pump means for dispensing precise quantities of liquids onto a series of segments of a length, wherein the amount of liquid being dispensed onto each of said segments, during any given time interval,
by the dispenser associated with each of said segments,
is responsive to the frequency of digital pulses during said time from a computer control,
means directed to the dispensers feeding each of said segments,
means for supplying said liquid to a plurality of said dispensing means,
means for regulating the dispensing rate of said measured amounts,
wherein the liquid dispensing means consists of a peristaltic pump.
so disposed as to control the rate of dispensing of said precise quantities such that the dispensing of said liquid is a substantially continuous stream.
